(19) United States
(12) Patent Application Publication
(10) Pub. No.: US 2011/0007264 A1
(43) Pub. Date: Jan. 13, 2011

(54) READING GLASSES

(76) Inventor: Zhang Desheng, Wenzhou (CN)

Correspondence Address: Law Office of Sergei Orel, LLC, Suite 185, 1 Bridge Plaza North, Fort Lee, NJ, 07024, US

(21) Appl. No.: 12/719,003

(22) Filed: Mar. 7, 2010

(30) Foreign Application Priority Data
Jul. 9, 2009 (CN) 200920222405.4

(51) Int. Cl. G02C 11/04

(52) U.S. Cl. 351/158

(57) ABSTRACT

The present new utility model discloses a pair of touch type eyeglasses with lighting functions, comprising a pair of eyeglasses and lighting devices disposed thereon. Said lighting devices are disposed symmetrically on the legs on both sides of the eyeglasses. Said lighting device comprises a light, said light being connected to a touch switch in an IC integration control module and a power source in turn. Said power source comprises two 3V batteries, a battery enclosure is disposed on said eyeglass leg, and said batteries are installed in the battery enclosure. Said light is a LED light. Said eyeglasses are presbyopic glasses. Compared to the prior art, the present new utility model is capable of providing sufficient illumination at a location with inadequate lighting, poor lighting or no lighting. Moreover, the touch switch is practical and convenient. When lighting is inadequate, the LED is turned on by one touch to light up objects to be viewed, which can be turned off by one touch when it is no longer needed. The present new utility model is particularly suitable for presbyopic glasses to avoid visual fatigue caused by poor lighting, and has advantages including reasonable design and simple structure.

### BACKGROUND OF THE INVENTION

This application claims priority of Chinese application No. 200920222405.4, filed on Sep. 7, 2009.

1. Field of Invention

The present invention relates to a pair of eyeglasses, in particular, to a pair of touch type eyeglasses with lighting functions.

2. Description of the Related Art

Currently known presbyopic eyeglasses simply strengthen presbyopic function thereof. In actual daily life, however, users of presbyopic eyeglasses often experience visual inconvenience due to lighting problems, and in particular, tend to feel visual fatigue after long period of eye use under poor lighting.

### SUMMARY OF THE INVENTION

To solve the drawbacks of the prior art, the present invention provides a pair of touch type eyeglasses with lighting functions that makes it easy to clearly view objects under poor lighting.

The technology employed by the present invention to solve the technical problems is: a pair of touch type eyeglasses with lighting functions, comprising a pair of eyeglasses, lighting devices being disposed on said eyeglasses.

Said lighting devices are disposed symmetrically on the legs on both sides of the eyeglasses.

Said lighting device comprises a light and an IC integration control module, said light being connected to a touch switch in an IC integration control module and a power source in turn.

Said power source comprises two 3V batteries, a battery enclosure is disposed on said eyeglass leg, and said batteries are installed in the battery enclosure.

Said light is a LED light.

Said eyeglasses are presbyopic glasses.

Compared to the prior art, the present invention is capable of providing sufficient illumination at a location with inadequate lighting, poor lighting or no lighting. Moreover, the touch switch is practical and convenient. When lighting is inadequate, the LED is turned on by one touch to light up objects to be viewed, which can be turned off by one touch when it is no longer needed. The present invention is particularly suitable for presbyopic glasses to avoid visual fatigue caused by poor lighting, and has advantages including reasonable design, simple structure and convenient use.

### DESCRIPTION OF THE DRAWINGS

FIG. 1 schematically illustrates the structure of the present invention.

FIG. 2 is a wiring diagram of the present invention.

### DETAILED DESCRIPTION OF THE INVENTION

The present invention is further described below with reference to the accompanying drawings, which nevertheless do not restrict the present invention.

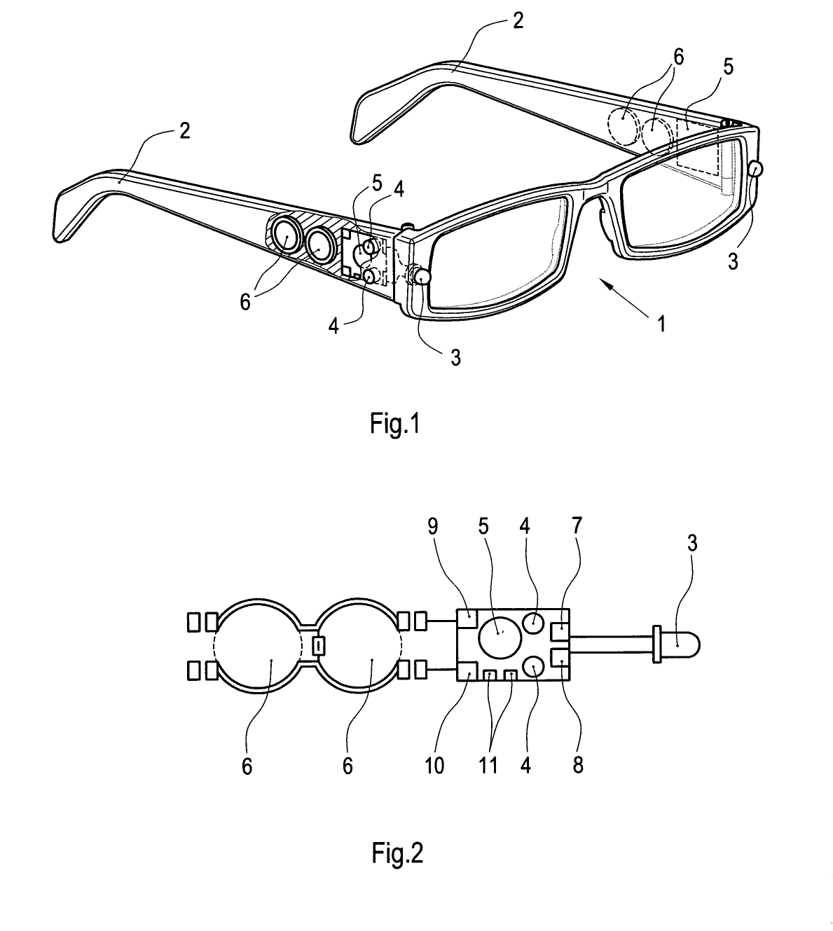

FIG. 1 shows a pair of touch type eyeglasses with lighting functions, comprising a pair of eyeglasses 1, lighting devices being disposed on the glasses 1, the lighting devices are disposed symmetrically on the legs 2 on both sides of the eyeglasses, the lighting device comprises a light 3, the light 3 being connected to a touch switch 4, an IC integration control module 5 and two 3V batteries 6 in turn. A battery enclosure is disposed on the eyeglass leg 2, and the batteries 6 are installed in the battery enclosure. The light 3 is preferably a LED light.

As shown in FIG. 2, the light 3 is connected to the positive and negative poles 7, 8 of the IC integration control module via electric wire, and then connected in series to the touch switch 4, the IC integration control module 5, positive and negative power connections 9, 10, and the batteries 6 in turn form a circuit, and the batteries 6 are formed by two 3V batteries connected in series. Touch the touch switch 4 and the light 3 is turned on to illuminate, touch the touch switch 4 again, the IC integration control module 5 breaks the circuit, and the light 3 does not illuminate. The IC integration control module 5 comprises the touch switch 4 and resistors 11, the resistors 11 control voltage and current in the entire circuit, IC stands for integrated circuit, which integrates a variety of electronic devices and components on a silicon wafer to realize circuit modules with certain specific functions, the role of the IC in the present invention is to effectively control switch and circuit security.

The present invention overcomes the drawbacks of existing presbyopic glasses that lack lighting functions and cause poor vision under inadequate lighting, and strengthens the brightness for vision through presbyopic glasses. Said glasses not only have presbyopic functions, but also are capable of real time control light-emitting sources to conveniently light up objects to be viewed.

The above embodiment is only one of preferable embodiments of the present invention. Common variations and substitutions made by those skilled in the art without departing from the scope of the present invention shall be embraced in the protection scope of the present invention.

1. A pair of touch type eyeglasses with lighting functions, comprising a pair of eyeglasses, characterized in that lighting devices are disposed on said eyeglasses.

2. The touch type eyeglasses with lighting functions of claim 1, wherein said lighting devices are disposed symmetrically on the legs on both sides of the eyeglasses.

3. The touch type eyeglasses with lighting functions of claim 2, wherein said lighting device comprises a light and an IC integration control module, said light being connected to a touch switch in an IC integration control module and a power source in turn.

4. The touch type eyeglasses with lighting functions of claim 3, wherein said power source comprises two 3V batteries, a battery enclosure is disposed on said eyeglass leg, and said batteries are installed in the battery enclosure.

5. The touch type eyeglasses with lighting functions of claim 3, wherein said light is a LED light[s].

6. The touch type eyeglasses with lighting functions of claim 1, wherein said eyeglasses are presbyopic glasses.
